(19) United States
(12) Patent Application Publication
(10) Pub. No.: US 2005/0185225 A1
(43) Pub. Date: Aug. 25, 2005

(54) Methods and apparatus for imaging documents

(76) Inventors: Dennis E. Brawn, Avondale, AZ (US); James M. King, Peoria, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/021,105

(22) Filed: Dec. 23, 2004

Related U.S. Application Data
(63) Continuation-in-part of application No. 10/735,330, filed on Dec. 12, 2003.

(51) Int. Cl. H04N 1/00

(52) U.S. Cl. 358/401; 358/486

(57) ABSTRACT

Methods and apparatus for imaging systems according to various aspects of the present invention provide a system for making physical copies of images and generating electronic images in an accessible format. The imaging system suitably includes a scanner and a control system. In one embodiment, the scanner makes copies of the documents or other images and substantially concurrently stores image data corresponding to images. The control system controls the scanning process and/or the handling of the generated images.

### FIELD OF THE INVENTION

The invention relates to methods and apparatus for making and managing images.

### BACKGROUND OF THE INVENTION

Modern electronic and optical data storage systems store vast amounts of information, far more than ever possible using conventional paper and ink. Current storage media, such as CD ROMs and DVD ROMs, can store on a single compact medium more information than may be contained in a file cabinet full of documents. The information on an electronic or optical medium is also easy to access and organize using databases and search systems.

Nonetheless, paper persists as a common medium. In many cases, the storage and indexing difficulties associated with paper documents are tolerated in view of paper's familiarity and simplicity. Such documents accumulate over time into large collections of paper and files.

Various circumstances arise, however, that require the documents to be stored, transported, sorted, and/or reviewed, such as in a complex litigation case or document management environment. Converting the paper to opto-electronic form for transport, storage, indexing, and retrieval involves feeding each document through a scanner, which makes an electronic image of the document and stores it. The image may then be withdrawn from data storage at a later time for review, printing, or organization.

Processes for making and organizing images of documents tend to be complex and difficult. Generally, scanning large volumes of documents has required a system administrator or other relatively high-ranking individual to set up a scanning project and assign the project to a scanning operator. The scanning operator, who is ordinarily a trained operator, scans the documents, which creates a series of electronic images of the documents. The administrator then assigns the project to a quality-control operator, who then reviews the images to ensure that they are accurate and complete. Finally, to generate hard copies of the documents, the electronic images may be then printed and reassembled.

Copying processes, though simpler, tend to be cumbersome as well. In a typical copying environment, the operator copies the documents on a copying machine and then reassembles and reviews the copies. To mark the copies with reference numbers, stickers bearing the reference numbers are attached to the documents. The labeled copies are then copied again to make additional copies of the marked set of documents.

Document imaging is rendered even more difficult by the presence of physical organizing elements commonly found in physical filing systems, such as staples, folders, and rubber bands. In many cases, such as litigation matters, preserving the original organization of the documents may be important. Consequently, the process of imaging and copying such documents is often a monumental and expensive task.

In addition, modern communication systems use much more than just paper. Vast amounts of information reside in electronic storage in various formats. Like paper document, the electronic information may need to be assembled and organized. Retrieving, interpreting, and organizing this information into a single accessible form, however, presents an enormous task.

### SUMMARY OF THE INVENTION

Methods and apparatus for imaging systems according to various aspects of the present invention provide a system for making physical copies of images and generating electronic images in an accessible format. The imaging system suitably includes a scanner and a control system. In one embodiment, the scanner makes copies of the documents or other images and substantially concurrently stores image data corresponding to images. The control system controls the scanning process and/or the handling of the generated images.

### BRIEF DESCRIPTION OF THE DRAWING FIGURES

A more complete understanding of the present invention may be derived by referring to the detailed description when considered in connection with the following illustrative figures. In the following figures, like reference numbers refer to similar elements and steps.

FIG. 1 is a block diagram of an imaging system according to various aspects of the present invention;

FIG. 2 is a block diagram of various functions performed by the imaging system;

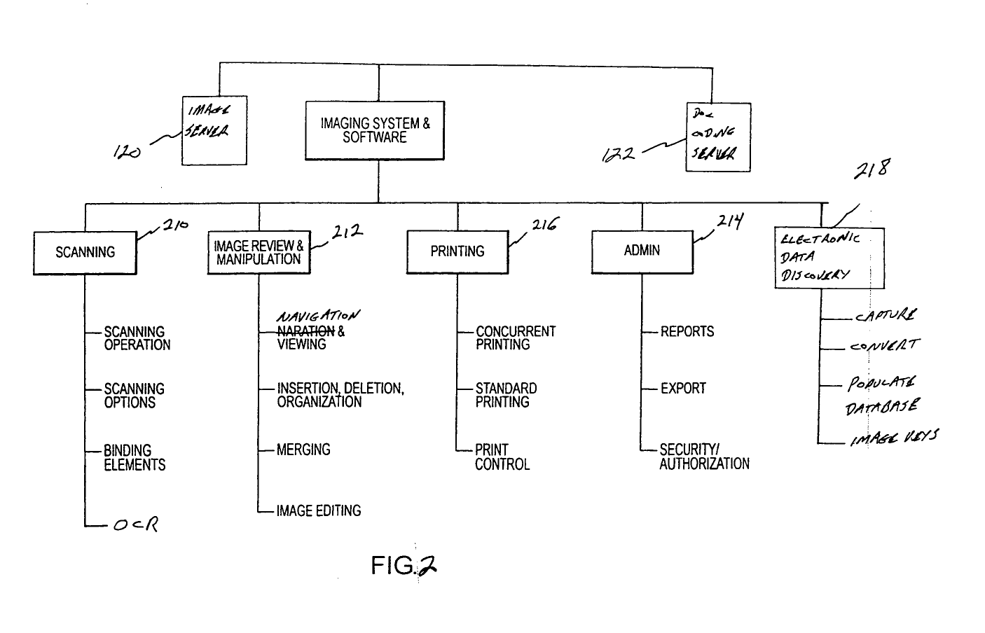

FIG. 3 is a flow diagram of a process for making images;

FIG. 4 is a flow diagram of a process for scanning documents;

FIG. 5 is an interface display for an initial display;

FIG. 6 is an interface display for a main display;

FIG. 7 is an interface display for a main display including a binding elements display;

FIG. 8 is a flow diagram of a process for conversion of electronic data to image data;

FIG. 9 is an interface display for a main display including thumbnails of images; and

FIG. 10 is a flow diagram of a process for document coding.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention is described partly in terms of functional components and various processing steps. Such functional components and processing steps may be realized by any number of components, operations, and techniques configured to perform the specified functions and achieve the various results. For example, the present invention may employ various elements, materials, data sources, copiers, scanning systems, printing systems, storage systems and media, and the like, which may carry out a variety of functions. In addition, although the invention is described in the document and electronic data copying and imaging context, the present invention may be practiced in conjunction with any number of applications, environments, scanning and storage processes, document management systems, information transfer systems, and copying systems; the systems described are merely exemplary applications for the invention.

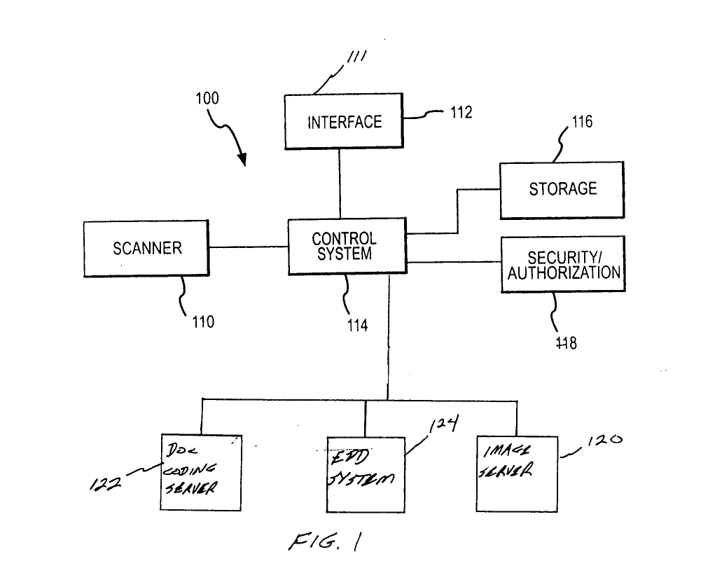

Referring to FIG. 1, an imaging system 100 according to various aspects of the present invention comprises a scanner 110; an interface 111; a control system 114; and a storage system 116. The scanner 110 generates copies and/or electronic data corresponding to images, such as documents, drawings, photos, and/or medical images. The interface 111 provides a system for communicating with operators or external systems. The control system 114 controls various aspects and operations of the imaging system 100 and generates organizational information associated with the images, and the storage system 116.

The various components of the imaging system 100, including subcomponents and/or functions of the imaging system. 100, may be integrated into a single machine, or may comprise multiple interconnected systems. The imaging system 100 may comprise a standalone system or a portion or element of a greater network, or may be a standalone system or several systems connected to each other and/or other systems to facilitate information transfer, for example directly or indirectly via a network, such as the Internet, a wide-area network, a wireless network, or other communication system. In addition, the imaging system 100 may be configured to support multiple computer languages, and may operate in conjunction with one or more application programming interfaces (APIs) and/or load files to facilitate communication between the imaging system 100 and other programs and systems.

The scanner 110 may comprise any suitable system for making electronic image data corresponding to original documents, images, electronic files, or other information, such as a conventional document scanner 110, a camera system, a medical imaging system, or the like. A document may comprise any suitable item for imaging, such as a physical or electronic document comprising one or more pages and/or one or more pages of drawings. The scanner suitably converts the information into an image format such that the original document or other object may be presented as an image, such as a .jpeg, .tiff, or .pdf file. The format for all images generated by the scanner 110 may be the same for easy access to the images. The particular format may be selected by the operator or predetermined.

In the present exemplary embodiment, the scanner 110 suitably comprises a multi-function device for making copies and electronic image data in one or more image formats corresponding to documents and photos. The scanner 110 also may also operate as a printer and/or facsimile machine. In the present embodiment, the scanner 110 comprises a Canon ImageRUNNER 7200, 8500, or 105 multi-function device (MFD); a Canon 5000i, 5020i, 6000, 6020, 3300, 3300i, or 3320i MFD; a Ricoh 2105, 2090, 1075, or 2045 MFD; a Gestetner 10512 or 9002 MFD; a Lanier LD0005 or LD090 MFD; a Savin 40105 or 4090 MFD; a Konica 7085, 7155, or 7165 MFD; or other appropriate MFD. In alternative embodiments, the scanner may comprise individual components, such as a scanner and a printer individually controlled by the control system 114, or other suitable imaging system.

The scanner 110 may be configured in any appropriate manner for the application or environment. The scanner 110 may offer various features for document handling, such as an automatic document feeder (ADF), a sorter, multiple paper sources, duplexing, stapling, and hole-punching. Images may be scanned and reproduced according to any color selection or scheme, such as color, gray-scale, or black-and-white.

In addition, the scanner 110 is suitably configured to receive control signals from the control system 114 or other source. The scanner 110 may operate in conjunction with signals from multiple sources, such as an internal control system, a dedicated external control system, and/or an external computer system. The scanner 110 may include one or more communications ports, such as an Ethernet port or a USB port, to facilitate communication with external systems. The scanner 110 of the present embodiment is configured to interface with one or more communication systems, formats, and protocols, such as e-mail, I-Fax, FTP, and/or local area networks.

The interface 111 transfers information between the imaging system 100 and external systems, such as other machines, operators, or observers. The interface 111 may comprise any suitable system for transferring information. For example, the interface 111 suitably includes an operator interface 112 for providing visual and/or audible information to the operator and receiving instructions from the operator. The operator interface 112 may comprise any suitable system, such as a conventional computer, monitor, keyboard, tracking device, voice recognition system, speaker, and/or other suitable system for transmitting information to and/or receiving information from the operator. In the present embodiment, the operator interface 112 includes a touch screen display. The operator interface 112 may also include a voice recognition system configured to receive verbal information from the operator, such as operational commands.

The operator interface 112 suitably provides an integrated control interface for communicating with the scanner 110 and/or the control system 114. The imaging system 100 may be configured such that all major functions of the imaging system 100, such as setting up scanning, printing, and/or copying operations, may be accessed and controlled via the operator interface 112. In addition, at least one component of the operator interface 112, such as a touch screen display, is suitably located near the scanner 110 and the control system 114 to present an intuitive relationship with the scanner 110 and the control system 114.

In the present embodiment, the operator interface 112 presents one or more graphical interfaces for providing information to and receiving commands from the operator. The imaging system 100 suitably operates in conjunction with a set of default or preselected parameters, such as default storage locations for electronic images and image formats. The default parameters may be selectively changed, for example via the graphical interfaces presented on the interface operator 112 or via a remote system, such as an administrator's workstation. In addition, the interface 112 may selectively display the electronic images of the documents, for example to facilitate quality control or other monitoring of the copying and/or imaging process. In the present imaging system 100, the operator interface 112 may selectably provide or receive information in various languages. For example, the operator interface 112 may be configured to communicate in English, Spanish, German, or French according to the selection of the user.

The control system 114 suitably controls one or more operations of the imaging system 100. The control system 114 may comprise any suitable system for controlling imaging system 100 operations. For example, the control system 114 suitably comprises one or more computer systems, such as a personal computer system or a set of communicating computers, connected to the scanner 110 via a parallel or serial cable, a wireless connection, a network, or other suitable mechanism for facilitating the exchange of signals between the scanner 110 and the control system 114. The control system 114 may include an internal computer or controller, such as a computer integrated into the scanner 110 or added as a component, for example via a card connected via a card slot. The control system 114 suitably includes any appropriate resources, such as a processor, fast memory, network access card, and hard drive.

The control system 114 suitably performs various operations to control the operation of the imaging system 100 in conjunction with an imaging system program. For example, the control system 114 suitably executes the imaging system program to control initiation and termination of scanning, converting, printing, merging, deleting, and other operations. The control system 114 also facilitates interfacing with the operator via the operator interface 112 to control the operation of the imaging system 100 according to the directions of the operator. Further, the control system 114 may be configured to manage the images, such as managing and/or performing optical character recognition (OCR), storing the images, initiating and controlling document coding, creating new document collections, merging document collections, automatically purging collections after a selected period or according to other criteria, and database maintenance. The control system 114 may also regulate various other aspects of the imaging system 100 operation, such as access to and by other systems, resource allocation, and/or coordinating operation with other systems.

In the present embodiment, the control system 114 has direct access to a scanning and copy engine residing on the scanner 110, for example via a scanner 110 interface, a scan-to-file interface, a TWAIN interface, or an API, to initiate scans and return image handles to the control system 114, set scan parameters such as simplex/duplex, ADF/flatbed, and paper size, and perform other functions. The control system 114 may also include any suitable drivers for operating the imaging system 100. For example, the present control system 114 operates in conjunction with a PCL5e driver, which may support paper tray and paper size settings, auto-stapling features, raster graphics settings, simplex/duplex control, and starting and stopping print jobs.

The imaging system 100 may also include and/or have access to other resources, such as according to the application or environment. For example, the imaging system 100 may include a storage system 116, such as a random access memory (RAM), a local or remote hard drive, a CD ROM and/or DVD burner, or other suitable system for short-term and/or long-term storage of image data. In the present embodiment, the storage system 116 comprises a mass storage system for storing and retrieving images and other data, such as a hard drive array.

The imaging system 100 may include various additional systems for generating, storing, manipulating, and using the images. For example, the imaging system 100 of the present embodiment suitably includes an image server 120 for controlling access to the images, a document coding system 122 for facilitating indexing of the images, a security and authorization system 118 for controlling access to the imaging system 100, and an electronic conversion system, such as a data discovery (EDD) system 124, for generating electronic images of and otherwise processing electronic files. The various systems, functions, and features may be implemented on any appropriate system and in any suitable manner, such as sharing resources with the control system 114, operating on a remote computer system, operating on a client system, operating within the scanner 110, or other suitable implementation.

The image server 120 controls and facilitates access to images over networks. In the present embodiment, the image server 120 is connected to the control system 114 via a network connection. The image server 120 may be connected via any suitable connection, such as direct connection to the scanner 110 or control system 114, wireless connection, or other communication system. The image server 120 is suitably configured to receive and store images from the scanner 110 and facilitate and control access to the images by the control system 114 and other systems. The control system 114 may be configured to automatically or manually transfer images generated by the scanner 110 to the image server 120. The images may then be accessed remotely via the network for any suitable purpose, such as review, printing, manipulation, or coding.

The imaging system 100 may also include the electronic conversion system to generate images and related data based on electronic information, such as electronic files, e-mails, and databases. In the present embodiment, the EDD system 124 captures electronic data, processes the file data to generate images, and provides the images for storage and use. For example, the EDD system 124 may include a computer that analyzes electronic documents in various formats, such as text files, image files, e-mails, word processing files, graphic files, database files, and the like, and converts them to one or more known formats, such as an image format. The EDD system 124 may perform the conversions based on file-type extensions of the documents to be converted, the properties of the files, or other characteristics, such as information contained in the header or other relevant portion of the document. The EDD system 124 may be implemented in any suitable manner, such as on the scanner 110, the control system 114, or other system. EDD processes may be initiated and controlled at the operator interface 112 or via another system such as a remote computer, and may access data stored at any suitable location, such as on a CD ROM disc in a local drive, a remote storage device via a network, or a local hard drive.

The imaging system 100 also includes the document coding system 122 to facilitate creation, execution, and management of coding projects and batches. Document coding may employ any system or process for recording indexing information relating to the images, for example according to document type, keywords, financial transactions, sources or addressees, and/or other criteria. Indexing information may be associated with the various documents to facilitate organizing and searching the images. The document coding system 122 may comprise any suitable system for managing or facilitating document coding, such as a computer connected to other systems via a network. The document coding system 122 may also be implemented on or integrated into the same computer as one of the other systems, such as the scanner 110, the control system 114, or the image server 120.

The document coding system 122 of the present embodiment may comprise any suitable document coding system, such as the CODE-IT or VCode document coding systems from IPRO Tech Inc. The control system 114 may be configured to automatically or manually transfer images generated by the scanner 110 to the document coding system 122. The document coding system 122 may then provide an integrated, process-oriented approach to document coding and accommodate coding from paper, image data, electronic files, or other sources. The document coding system 122 may facilitate document coding locally or remotely, such as over the Internet or a local area network. To facilitate document and performance management, the document coding system 122 may assign users to coding teams to which projects are allocated. The present document coding system supports multiple domains, allowing physically isolated systems to reside on the same web server using the same IP address to optimize hardware use without sacrificing security.

The document coding system 122 suitably handles various aspects of the coding process, such as project definition and setup, unitization, coding, quality control, data validation, and export of the completed coding files. The document coding system 122 may allow a project to be divided into batches to facilitate the flow of work through each phase of the process. Further, the document coding system 122 may include a security system to specify which users may perform certain functions and inhibit inappropriate access to project definitions, coded data, document images, and other restricted information. The document coding system 122 may also provide reports to track the progress of batches, shipments, and projects, monitor and manage project productivity, and estimate completion times. Further, the document coding system 122 suitably allows automatic checking of overlaps and gaps, and provides back end processing to ensure data integrity. The document coding system 122 may also provide for image key validation, required fields, validation, names consistency, spell-checking, and image key gap detection.

The imaging system 100 may also include the security and authorization system 118 to inhibit improper access to the imaging system 100 and control authorized access. In the present system, the security and authorization system 118 includes a counting system implemented by a dongle to facilitate use of the imaging system 100. The dongle counts the number of images generated by the imaging system 100 or tracks other suitable data to determine the use of the system, and locks the imaging system 100 to prevent further use if selected criteria are met, such as exceeding an authorized number of images. The operator may unlock the imaging system 100 for further use by purchasing another dongle or having the dongle reset for an additional number of images.

Security and authorization functions may also be integrated into the control system 114 or implemented by one or more elements of the imaging system 100, such as the security and authorization system 118, the control system 114, the document coding system 122, the scanner 110, and/or another computer. For example, the control system 114 and the various networked systems may be configured to accommodate a hierarchy of groups and/or users, such as administrators and users, having different user rights, such as rights to access files and directories, delete or purge files, merge boxes or other groupings of files or images, adjust configuration settings, set up projects with customer information, matter information, job information, and the like.

The imaging system 100 according to various aspects of the present invention and its various elements provide functions and operations to facilitate making copies of information, generating electronic images of the information, and managing, printing, and/or exporting the images. For example, the imaging system 100 may execute an imaging program to control various aspects of the scanner 110 to control the generation and storage of the images. The imaging system 100 may perform these functions to provide greater control and flexibility in image generation, storage, and management than may be available using a conventional system, such as the scanner 110 alone. In addition, the functions are suitably presented to the user via graphical user interfaces and/or a voice recognition system that facilitate the simple, intuitive use of the system.

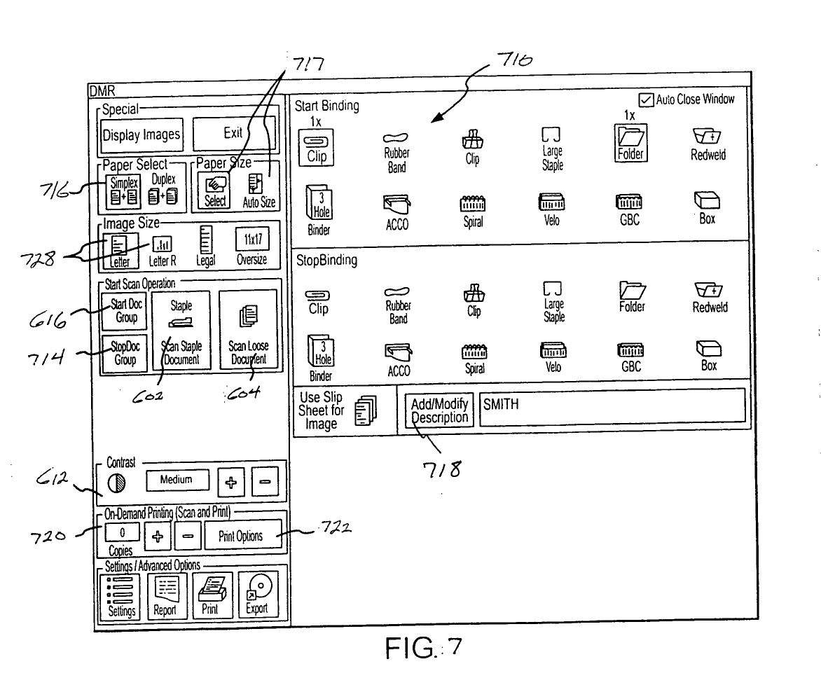

In the present embodiment, the control system 114 and other elements of the imaging system 100 provide several functions for the generation, management, and use of the images. Referring to FIG. 7, the control system 114 may provide scanning instructions 210 to the scanner 110 to generate and store images and printing functions 216 for generating copies of the images. The control system 114 and/or other systems may also provide image review and manipulation functions 212 for sorting, reviewing, and adjusting the images, and administrative functions 214 for controlling the overall operation of the system and handling of the documents.

Other systems may also provide additional functionality to the image system 100. For example, the EDD system 124 provides the capture and conversion functions 218 for processing electronic data, populating relevant databases with information relating to the converted data, and generating image keys for the various images. Further, the image server 120 performs storage and management functions for the stored images, for example in conjunction with a database, for local and remote retrieval, manipulation, and storage of the images and associated data. The document coding system 122 functions provide coding capabilities to organize information relating to the images. Thus, the imaging system 100 may provide these and/or other functions for generating, storing, organizing, and reproducing documents and information from a wide array of sources.

To generate images, the imaging system 100 may use the scanner 110 to emulate a process for generating copies of documents while concurrently generating electronic images of the documents and storing them. For example, the scanner 110 may be configured to receive the documents for imaging using a conventional copying process, such as loading the documents into an automatic document feeder or other intake mechanism on the scanner 110 and copying the documents in response to pressing a button or other mechanism for starting the copy process. While the scanner 110 makes the physical copies of the documents, the control system 114 may configure the scanner 110 to substantially concurrently perform other functions, such as generate and store electronic images of the documents, print additional copies, transfer images to a quality control station, the document coding system 122, and/or the image server 122, perform automatic quality control, perform optical character recognition, generate load files for importing the data into other applications, and insert image keys.

The scanner 110 suitably operates in conjunction with a set of default or other preselected parameters, such as default imaging properties, storage locations, and image keys. For example, the scanner 110 may be configured to automatically generate a physical copy and an electronic image in a particular image format, assign an image key to the image, insert the image key into the image, use the image key to name the image, and store the image in a particular location. The images may also be automatically transferred to the image server 120 for storage and access, as well as to the document coding system 122 for coding. Consequently, the operator may make the physical copies and/or electronic images with minimal effort, training, or familiarity with the scanner 110 or control system 114.

The scanner 110 may operate in conjunction with various features and operations. For example, the control system 114 may automatically detect and store various characteristics associated with the document, such as the size of the original document and whether the original document is a simplex or duplex document, and store the information with the image. To identify blank pages, the control system 114 may utilize a capture threshold, which may be automatically or manually adjusted. For example, the control system 114 may compare an amount of data on the document to the capture threshold and generate the image of the document only if the amount of data exceeds the capture threshold. To generate the physical copy, the scanner 110 may match the original features to recreate the original format and size, or change particular features, such as printing all documents as simplex or adjusting the image size. Documents may be scanned, viewed, and/or printed in color, monochrome, or gray-scale according to any suitable criteria, for example using color for exact reproductions and monochrome or gray-scale to conserve memory or toner.

In conjunction with generating images of the documents, the imaging system 100 may also generate organizational information associated with the images. The organizational information may comprise any suitable information relating to the organization of the original documents or information, such as boundary markers for individual documents, beginning and end markers for various binding elements, the identities of various binding elements, the names of folders and boxes, whether the image is a duplex image (i.e., taken from the backside of another page), or other information. The control system 114 may generate the information in any suitable manner, such as by automatically identifying and storing such information from the original documents, or receiving data, such as via the interface 112, relating to the organization of the documents and generating corresponding data. The control system 114 associates the organizational data with the images, for example to record the original organization of the documents.

In the present exemplary imaging system 100, the control system 114 and the imaging program may offer any suitable scanning operations for noting organizational information. For example, the scanning operations may include different handling options for documents organized in different ways. In particular, the scanning operations may include scanning processes configured to track the beginning and ending pages of a particular document. In the present embodiment, the scanning operations include a scanning operation dedicated to documents held together by staples, which are the most common binding element. Scanning operations may also provide a binding element process for recognizing the use of various other binding elements. The present system, for example, records the type of binding element used and its position relative to the images. The control system 114 may also facilitate entry and notation of documents associated with multiple binding elements or other organizational features, such as a stapled document in a folder in a box. The control system 114 may also note relationships between documents that signify a connection between the documents. For example, the control system 114 may allow a document to be designated as an attachment, appendix, enclosure, or other type of document related to another document.

The control system 114 may store the images and associated data at any appropriate location and according to any suitable process. In the present imaging system 100, the control system 114 stores the images and associated data in the storage system 116, facilitating access to the images by the interface 112, the control system 114, the document coding system 122, and other components that may be directly or indirectly connected. Images and other information may also be exported to or stored directly in the image server 120, for example at run time, automatically after the job is complete, or at another suitable time. The stored images are suitably accessed like other documents or image collections on a networked drive.

In the present exemplary embodiment, the control system 114 includes or is connected to an OCR system, such as a separate machine or a system integrated into another element of the imaging system 100 such as the scanner 110, to extract text from files having text and populate a database with the text information, such as word processing or text file data. Full text and/or meta-data information extracted from the electronic files may be used for search or filtering, such as in conjunction with comparing digital signatures, like MD5 hash signatures or bit-by-bit comparisons, to find duplicate files.

The scanning functions may include OCR functions, which may be initiated manually, for example by requesting OCR for a particular set of documents by a remote user, a nearby connected user, or by the operator. The OCR functions may also be configured to be performed automatically, such as concurrently with or immediately following the scanning process. In one embodiment, the OCR functions are performed by the scanner 110 or by a separate computer, such as the control system 114 or a remote computer, substantially concurrently with the imaging process so that processing a document may produce a physical copy, an electronic image, and an OCR file. The OCR results are suitably associated with the original documents, for example being merged into databases for a set of documents including the images, document coding information, and the like. In the present imaging system 100, OCR may be performed at the document level, for example generating single files of OCR data for multi-page image files. In particular, the OCR system may identify the beginning and end of a document by checking the boundary flags for the images. The OCR system may then integrate all OCR data for the images between the beginning and end of the document into a single OCR file for the entire document.

In the present embodiment, several functions may be performed concurrently. For example, upon scanning each page, the control system 114 may generate a physical copy, scan the image into memory, insert an image key, perform OCR to generate an OCR file, and/or generate a load file. Consequently, at the end of the scanning process, the relevant files have already been generated. If quality control requires changing the document collection, for example inserting a page, the necessary changes may be made to each file or other set of data relevant to the document at the same time without repeating operations for the entire batch.

The document coding system 122 may perform a document coding process to generate index information for the documents. For example, the document coding system 122 may facilitate project definition and setup, unitization, manual and/or automatic extraction of data from the electronic files generated by the imaging system 100, and population of coding fields. The document coding system 122 may use the extracted information for document coding index fields, for example by automatically or manually mapping selected data to selected coding index fields, or to otherwise assist in the organization of the information.

The imaging system 100 may also be configured to generate, store, and manage images from sources other than paper or other physical documents. For example, image data may be generated based on other electronic data, such as electronic files from a computer system to facilitate electronic data discovery. The EDD system 124 may be implemented in any suitable manner, such as by guiding the user through the process using dialog boxes to initiate processes and set parameters. The EDD process may be initiated and controlled at the operator interface 112 or via another system such as a remote computer, and may access data stored at any suitable location, such as on a CD ROM disc in a local drive, a remote storage device via a network, or a local hard drive.

The EDD system 124 may convert image data from various other formats into a single format, such as a JPEG or TIFF format. The control system 114 may also convert other types of electronic files, such as e-mails, word processing files, spreadsheet files, graphics files, engineering files, and the like, into a single format, such as an image format. The conversion may be facilitated in any suitable manner, such as by initiating conversion programs automatically according to file extensions or other file type designators or criteria, such as file header data. Thus, the EDD system 124 may receive an array of files in different formats and generate a series of images, in a manageable number of formats, representing the content of the files. The images are suitably converted to a single image format to facilitate review, coding, printing, and other uses.

The electronic files may also be processed like imaged documents. For example, images of electronic file content may be adjusted to include image keys. The electronic files are also suitably formatted to provide a familiar type of image for a viewer, such as providing document boundaries and adjusting image sizes to conventional sizes, such as 8.5″×11″ or A4 paper size. The organizational information may also be associated with the electronic files, such as position within directories, date of creation and last modification, and the like. The EDD system 124 may also perform related functions for using the images, such as extracting text and metadata from electronic files and performing OCR.

The EDD system 124 may also utilize search or filter criteria to identify material of interest, such as selected types of files and/or applications, beginning and ending dates for date ranges, words or phrases in the documents or meta-data, and the like. Different types of information or files may receive different treatment from the EDD system 124 according to any suitable criteria, such as generation of metadata, boundary level settings, coding fields, whether to assign image keys to the images, and the parameters for the image keys, such as format, starting number or letter, and location in the image.

Data relating to electronic files may be associated with image data generated from physical documents. In some cases, various physical documents and electronic files may relate to the same subject matter or otherwise be related. In the present exemplary imaging system, the control system 114 or other computer part of or linked to the imaging system 100 may associate image data, such as data stored on the image server, with relevant electronic files. Data generated based on electronic files and/or the electronic files themselves may be stored in a corresponding directory or otherwise linked to associate the image data with the electronic files. Electronic files and image data from physical documents may be uploaded and downloaded to the image server 120 or other storage location to effectively associate data with other data.

The image review and manipulation functions allow the generated images to be reviewed, sorted, adjusted, improved, and/or edited. For example, the imaging system 100 may include a viewing system, such as in conjunction with the interface 111, for viewing images generated by the imaging system 100. Images may be reviewed at any time, such as at run time (within seconds or minutes of the generation of the image) or at a later time. The image manipulation and review functions may be used at the position of the scanner 110, such as on the operator interface 112 or on a computer running the control system 114, or remotely, such as on a remote computer having access to the generated images, such as via the image server 120. The image manipulation and review functions 212 may be used for any suitable purpose, such as to perform quality control to ensure that the images and organizational information accurately reflect the original documents and correct any deficiencies. The image manipulation and review functions 212 may include, for example, image navigation to find selected images, image insertion and deletion, organization functions for changing the document collection, and image editing functions for adjusting various aspects of the images, such as contrast, despeckling, rotation, margins, clipping, and shrinking/enlarging. The image manipulation and review functions 212 may also include automatic removal of blank pages, including front or back pages, from the image collection, and removal of black borders from images, for example borders formed while scanning due to small documents against a flatbed scanning surface or black borders in an original document. For example, the data around the edges of a document may be compared to a density threshold to identify the black borders. Thresholds for identifying black borders and/or blank pages may be adjusted automatically or manually.

Image viewing may be implemented in any suitable manner to allow a user to view the images. For example, the operator may view the images via the operator interface 112. Similarly, remote viewers may initiate a viewer program and load images from storage, such as the storage system 116 or the image server 120. The user may then navigate through the images to find desired images, such as by selecting particular image keys or file names or paging through one or more documents. Upon finding a particular image, the user may delete the image, adjust the image or associated data, move the image to another location in the collection, or perform any other appropriate function. The image manipulation and review functions 212 may also facilitate rescanning of a group of images for insertion within the collection of documents.

Further, the scanner 110 may selectively insert reference numbers or other image keys into the scanned images. The insertion of image keys may be selectively enabled or disabled, either automatically according to selected criteria or manually. As each image is generated, the control system 114 may insert an image key, such as a Bates number or other suitable reference number, into the image. In the present embodiment, the image key is suitably integrated into the image data of the document and becomes part of the image itself. Alternatively, the image key may be assigned to and associated with the image file. The images may then be immediately printed with the image key and/or stored.

Image keys may be configured in any suitable manner or format, such as alphanumeric and upper and lower case characters, customized prefixes and suffixes, designation of a starting number with sequential increments, automatic removal of leading zeros, placement of the image key in a selected corner or along a selected side of the image, particular colors, and/or inserting additional information, such as a multi-line message, like an indication of confidentiality, a case name, or a designation of a court order, over the image key. The image keys may be automatically formatted, formatted according to a selection from a list, customized, or otherwise configured.

In the present embodiment, the operator may select a starting image key and configure the format and content of the image key. The image key may be used as or associated with the file name for the image, facilitating searching for particular documents. If the documents already include image keys, the control system 114 may use the same image keys for the generated images.

In addition, the control system 114 may add a suffix to the image key for the added documents. For example, if an image is added, the control system 114 may assign a suffix to a relevant image key to identify the added document's position in the sequence of documents. The suffix may comprise any suitable designator, such as a conventional alphanumeric suffix having one to three characters, and the format of the suffix may be configured automatically or manually. Thus, an image added after image 203 may be assigned an image key of 203-AA. If several images are added, the suffixes may be incremented without incrementing the original image key. Thus, three images added after image 203 may be designated in a sequential order as images 203-A, 203-B and 203-C. Upon renumbering, the control system may be configured to either retain or remove the suffixes. The control system 114 may also generate relevant flags, for example to designate whether the image is associated with a binding element, a document boundary, or the duplex side of another image.

The various image manipulation functions may also be implemented to operate in conjunction with the image keys. For example, functions such as image insertion and deletion may accommodate the image keys to maintain the integrity of the image key system. In the present embodiment, the control system 114 may renumber the image keys in the event that images are deleted from or added to the image collection. Thus, if images bearing image keys [1190] to [1195] are deleted from a collection, the control system may change the numbering of the following documents to reflect the document removal. Similarly, if one or more documents are inserted into an image collection between images bearing image keys [1190] and [1191], the control system 114 may renumber the documents following [1190] to accommodate the insertion and maintain a proper sequence of image keys. The renumbering may be implemented to occur automatically, manually, or interactively, such as upon a particular selected set of documents.

The renumbering may also be performed upon merged sets of documents. For example, three different boxes of documents may be scanned by the image system 100. If the documents are related, the boxes may be merged into a single set of documents as if they formed a single larger box of documents. In performing the merge, the control system 114 may generate the image keys such that one box receives a first sequence of image keys, the image keys for the second box continue from the end of the first box and the image keys for the third box continue from the end of the second box.

Furthermore, the imaging system 100 may facilitate reference to the various documents by designating image keys. For example, the image keys may be used to navigate to or delete a particular image or range of images. In the present system, the image data are stored in files having names corresponding to the image keys. Alternatively, the image keys may be associated with the file names or other storage information.

The imaging system 100 may also manipulate collections of multiple images. For example, the imaging system 100 may merge collections of documents into larger collections. In particular, a set of documents may be divided among several teams using several different scanners 110 to generate the images. Consequently, the images may form separate document collections having different and independent image keys. The control system 114 may merge the documents into a single collection, for example by defining a proper sequence for the document collections, redefining the image keys to form a single sequence, and adjusting the image keys associated with the various images.

The control system 114 may also operate in conjunction with the imaging software to perform printing and exporting functions. The printing functions may comprise any suitable set of functions for generating printed images, such as concurrent printing while scanning, and conventional print functions, such as standard printing and control functions. The printing, scanning, and other functions may be separately implemented to allow independent and/or concurrent functioning, such as printing an existing set of documents while scanning a new collection. The control system 114 and the imaging software may also support administrative functions, including exporting data for transferring data to other systems or media, generating reports, and controlling security and authorization.

For example, in the present exemplary imaging system 100, images may be printed at any time from any appropriate station having access to the images, including from the control system 114 and operator interface 112 associated with the scanner 110 or from a remote station. Images may be printed concurrently with scanning to emulate a conventional copier, and may also be printed later from storage. Printing may be performed by the scanner 110 or by another system, such as a remote printer.

Images to be printed may be designated in any suitable manner. For example, the user may navigate to a starting image and give instructions, such as to print a selected number of images from the starting image, print all images up to a designated ending image, or print a series of selected images. Further, the images to be printed may be designated according to the image keys associated with the various images. Any suitable set of printing options may also be provided, such as printer selection, number of copies to print, size selections, color selections, paper trays, and the like.

Images and related information may also be exported to other systems, such as for review, indexing, quality control, transmission to another computer or system, export to another medium, and integration into other content and applications. In the present imaging system 100, the control system 114 automatically exports image data and related data to the image server 120 for network access. Similarly, the control system 114 may export automatically export the data to the document coding system 122 to initiate a document coding session.

The imaging system 100 may also export data to other databases for various uses. For example, the imaging system 100 may export data to a major litigation database or application, such as DocuLex, Summation, and Concordance. The imaging system 100 may also generate reports to indicate the status and results of its operation, such as summaries of imaging jobs, detailed manifest reports, productivity reports for various users and teams, and job cost data.

The imaging system 100 of the present embodiment is suitably configured to generate, store, and/or process the image data in any suitable manner and according to any appropriate techniques. In the present embodiment, the imaging system 100 and the imaging system program are configured to generate the images in accordance with a process that resembles a copying process, but produces electronic images of the documents for review, transfer, or other processing. The imaging system 100 may also generate electronic images based on electronic files. Further, the imaging system 100 may be configured to print, store, perform OCR, perform document coding, or otherwise manage and handle the images, concurrently or consecutively. In the present embodiment, the imaging system 100 is configured to print the images along with various data to note the original organization and binding components of the documents.

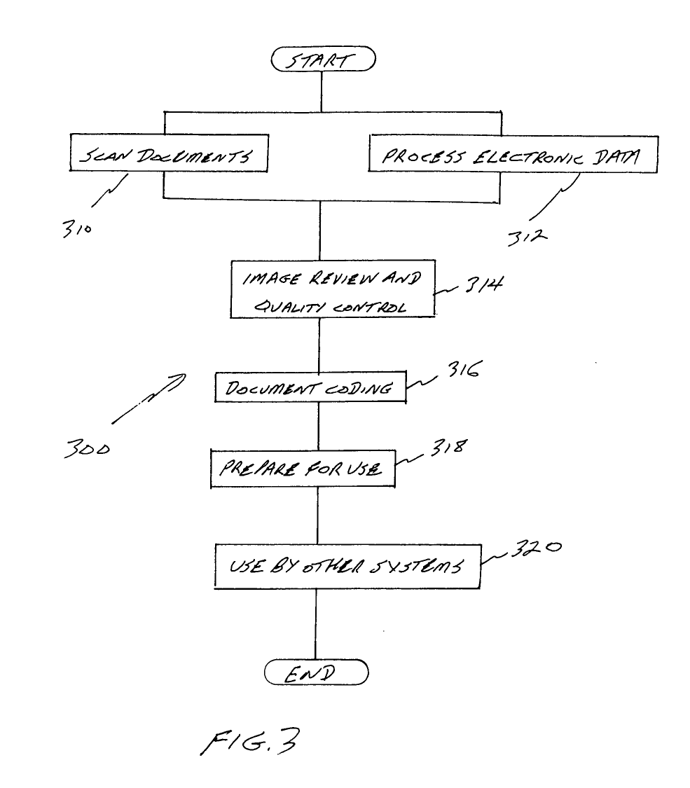

For example, referring to FIG. 3, an imaging process 300 according to various aspects of the present invention comprises scanning a collection of documents to generate electronic images and associated data (310). Further, the imaging process may include generating electronic images from electronic data (312). The images are suitably reviewed and/or modified, such as for quality control (314). In addition, the images may be processed to generate document coding information (316). The images and/or related information may then be processed for use (318), such as printing the images and exporting the images and related information to a medium along with related or otherwise useful data or applications. The images may also be reviewed and adjusted by other systems (320), such as a viewing application included on the storage media to which the images are exported.

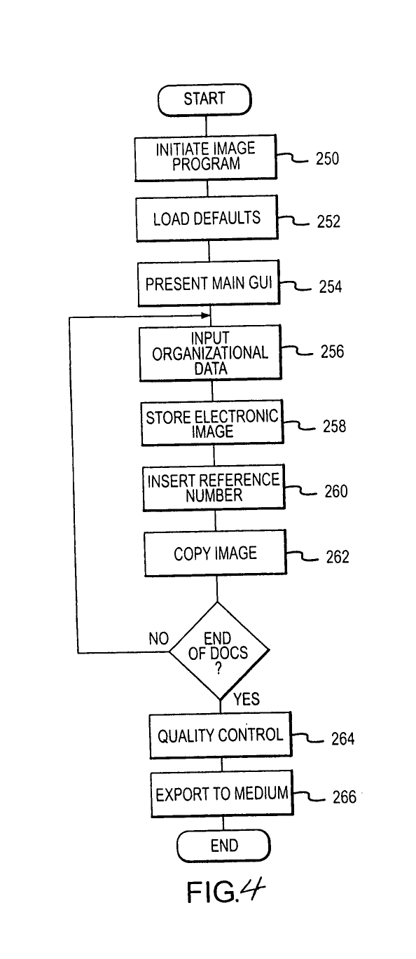

In particular, referring to FIG. 4, the control system 114 of the present embodiment initiates the imaging program (250), which loads one or more default parameters for operation of the imaging system (252). For example, the imaging program may load a default location for storing electronic images, configure the scanner 110 to generate physical copies of documents and electronic images, and set various scanning and printing default parameters for operating the imaging system 110. The default parameters may comprise any appropriate set of parameters to allow the operator to initiate the scanning process without entering additional information.

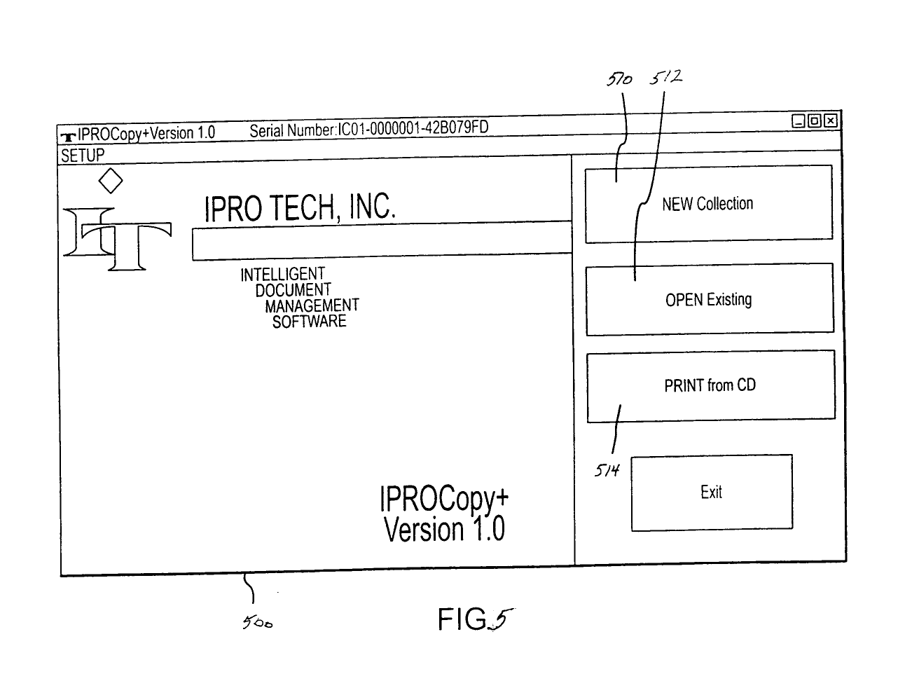

The imaging program may then prompt the user via the operator interface 112 to either enter the name of a new document collection or open an existing document collection. For example, referring to FIG. 5, the control system 114 presents an initial GUI 200 to the operator via the interface 112. The initial GUI 200 provides multiple processes from which the operator may select, such as starting a new document collection 210, opening an existing document collection 212, or printing from a storage medium 214. In the present system, a document collection may comprise any appropriate group of materials to be imaged, such as a box of documents, a set of records for a particular individual or entity, electronic data from a CD ROM or DVD, or other suitable grouping.

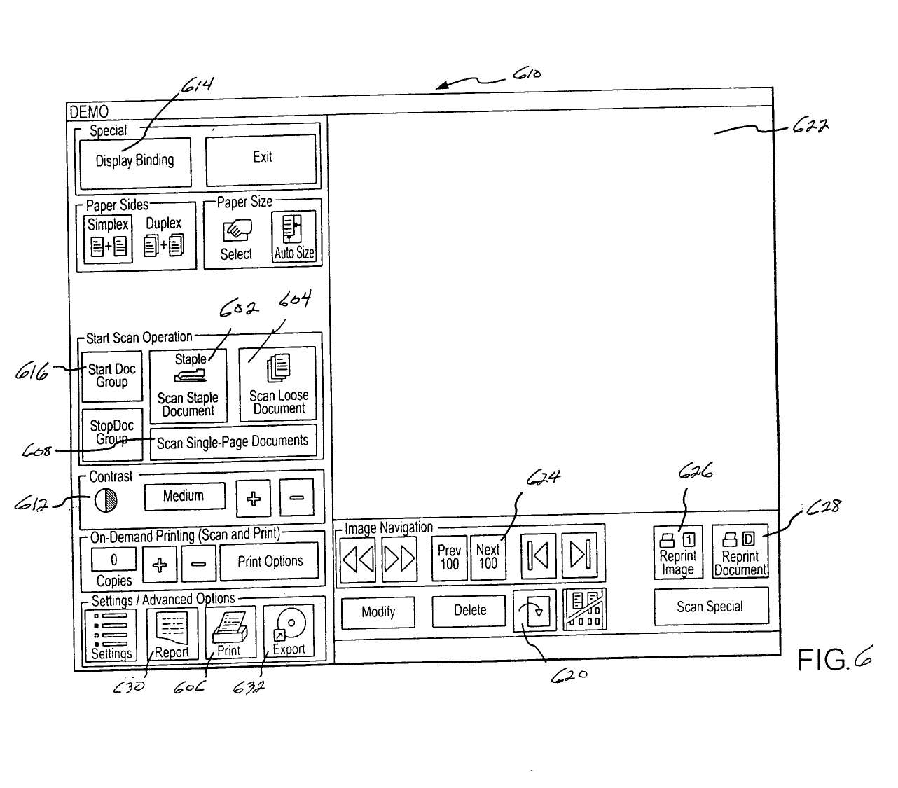

To initiate generating or manipulating image data, the operator selects to begin a new collection or identifies an existing collection to access, for example by selecting the appropriate button on the touch screen, typing the relevant information via the keyboard, or verbally commanding the control system 114 via a voice recognition system. After establishing the relevant document collection, the control system 114 facilitates various operations for the document collection, such as to review, print, modify, delete, add images to, export, perform OCR, or otherwise generate or manipulate the document collection or portions of the document collection. For example, referring to FIGS. 4 and 6, the control system 114 suitably presents a main GUI 610 on the interface 112 (254). The main GUI 610 provides one or more options for selection by the operator. For example, the operator may scan documents, adjust scanning parameters like contrast, simplex/duplex, paper size and special parameters, select print options, navigate through, modify, and delete images, generate reports, and export images. The operator may provide commands and other information via the operator interface 112, for example by selecting options from a touch screen, typing information on a keyboard, and/or speaking commands via a voice recognition system.

To initiate a scanning process, the operator may, if desired, initially adjust various scanning parameters, such as by using a contrast adjustment panel 312 on the main GUI 610 or changing various other settings, or use a set of default parameters. When the scan operation is initiated, the scanner 110 retrieves the documents from the ADF or other source and generates an electronic image of the document (258). The electronic image may comprise any suitable data corresponding to the image in any suitable format, such as bitmap, .jpeg, .tiff, or other format. In the present embodiment, the electronic image is stored in a proprietary format suitable for storage on electronic media and readable by a proprietary reader program.

The operator may also enter various organizational information relating to the set of documents (256). For example, to indicate the beginning of the document, the operator selects a suitable option from the main GUI 610, such as by tapping the SCAN STAPLE DOCUMENT button 602 if the document is stapled; SCAN LOOSE DOCUMENT 604 if the document is not associated with a binding element; SCAN SINGLE-PAGE DOCUMENTS 608 if the document is a single page; the DISPLAY BINDING button 614 (or speaking a corresponding phrase) if the document is bound with a binding element (other than a staple); or the START DOC GROUP button 616 (or phrase) if the document is part of a different type of document group, such as a group of pages having different sizes.

If the DISPLAY BINDING option is selected, the control system 114 initiates a binding elements system for identifying the binding elements associated with a document. The binding elements system may comprise any suitable system and/or process for identifying binding elements or other organizational data relating to a document or group of documents. Binding elements may comprise any suitable organizational elements found in a document collection, such as paper clips, staples, folders, three-ring binders, boxes, dividers, rubber bands, prong fasteners, and spirals. In the present embodiment, the binding element system includes a binding elements display 710 (FIG. 7) for identifying binding elements for the documents. The binding elements display 710 provides one or more binding element selections that may be selected to indicate the position of the binding element with respect to the document. In addition, the binding elements display 710 may allow identification of the type of binding element.

For example, the binding elements display 710 may present multiple touch screen buttons and/or verbal command options corresponding to different types of binding elements, such as staples, paper clips, rubber bands, folders, or other mechanisms for organizing pages. The present binding elements display 710 is separated into a Start Binding portion and a Stop Binding portion to allow the operator to indicate where the relevant binding elements begin and end with respect to the document. The binding elements display 710 is suitably presented in conjunction with at least a portion of the main GUI 610 to facilitate efficient selection of binding elements and initiation of scanning operations.

To scan the document, the operator selects the appropriate type and number of binding elements for the document. The operator may then remove the physical binding elements from the document. For example, a folder may contain two documents, the first of which is stapled and the second held together by a paper clip, in which case the operator removes the first document from the folder, removes the staple, and selects the FOLDER button on the Start Binding portion of the binding element display 410, or says “START FOLDER” to the voice recognition system. The operator may also enter a description, such as a label on the folder, by selecting the ADD/MODIFY DESCRIPTION button 718 or saying “ADD DESCRIPTION” and providing the desired description. As the description is entered, the control system 114 may automatically check the spelling of the text entered. The control system 114 may also provide a pre-loaded menu of possible descriptions, which may be modified by the operator or other personnel, from which the operator can select.

The operator may then place the pages to be scanned in the scanner 110, such as in the ADF, and select a scanning button or verbally initiate a scan. The scanning operation may vary according to the type of documents to be scanned. In the present embodiment, the control system 114 provides a SCAN STAPLE DOCUMENT option 602, a SCAN LOOSE DOCUMENT option 604, and a SCAN SINGLE PAGE DOCUMENTS option 608, each of which operates to generate image data corresponding to the content of the document and note various characteristics relating to the document, such as the position and/or type of binding elements or whether the image is the duplex side of another image.

The control system 114 generates organizational data for the document and associates the information with the document, such as by marking the individual images with flags relating to the image's position in a document or relative to a binding element. In the present embodiment, the control system 114 sets document boundary flags for images corresponding to the first and last pages of the document, as well as binding element flags for the pages at the beginning and end of a binding element. For example, the control system 114 may generate flags indicating that the first image corresponds to the first page in a stapled or paper-clipped set of documents, the first page in a folder of documents, and the first page of a document.

The organizational information may be designated and stored in any suitable manner. For example, in the present example involving the now unstapled first document, the operator taps the SCAN STAPLE DOCUMENT button 602 or says “scan staple document” for the voice recognition system. In response, the control system 114 initiates scanning of the documents in the ADF and automatically generates electronic document boundary indicators corresponding to the beginning and end of the document and the use of staples. The control system 114 of the present embodiment suitably generates a document boundary flag associated with the first page of the document indicating that the page marks the beginning of the document, a folder start flag designating the beginning of the documents in the folder, and a staple start flag indicating that the associated page is the first page in a stapled set of documents. Upon encountering the last page in the document, the control system 114 may generate one or more flags associated with the last page indicating that the page is the last page in the document and the last page in a stapled set of documents.

If the documents are held together by a different binding element, such as a paper clip, rubber band, a folder, or the like, the operator may select the SCAN LOOSE DOCUMENT option via a button 604 and/or verbal command. In the present imaging system 100, the operator identifies the type of binding element using the binding elements display 710 or verbal command, places the document in the scanner 110, and selects the SCAN LOOSE DOCUMENT option 604. The control system 114 begins scanning the documents and generates document boundary markers corresponding to the beginning of the document and flags for the relevant binding elements. The control system 114 may generate document boundary flags for the first and last pages in the document and binding element flags for the first and last pages associated with the binding element.

Thus, in the present example involving the second, paper clipped document in the folder, the operator unclips the document and places it on the scanner 110. The operator selects the CLIP button from the Start Binding portion of the binding elements display 710 and selects the SCAN LOOSE DOCUMENT button 604, or provides corresponding verbal commands to the voice recognition system in the operator interface 112. The control system 114 initiates the scanning process and generates the document boundary flags associated with the first and last pages of the document and a Start Paper Clip flag associated with the first page of the document. When the documents have been scanned, the operator selects the CLIP button and the FOLDER button from the Stop Binding portion of the binding elements display 710 or provides corresponding verbal commands, and the control system 114 generates corresponding flags associated with the last page of the document, the last page of the clipped pages, and the last page of the folder.

When the images have been scanned and copied, the documents may be retrieved from the scanner 110. The operator may then reattach the relevant binding element to return the document to its original form. The operator may then repeat the process for the next document. While entering the information for the next document, the operator suitably indicates the end of the previous binding elements as well by selecting the appropriate buttons from the Stop Binding portion of the binding elements display 710 or providing the appropriate verbal cues. For example, if the next document is a single page document after the folder in the preceding example, the operator selects the CLIP button and the FOLDER button from the Stop Binding area of the binding elements display 710 as described above, and selects the SCAN SINGLE-PAGE DOCUMENTS button 608, or in a system having a voice recognition system, provides corresponding verbal commands. The control system 114 stores a flag indicating that the preceding image corresponds to the end of the clipped pages and the end of the folder, and another flag indicating that the current page is a single-page document.

If the relevant document comprises a single page, the operator exits the binding elements display 710 and selects the SCAN SINGLE-PAGE DOCUMENTS button 608 or performs a verbal command. The control system 114 automatically sets flags indicating the start and end of the document for the same page, or a single-page document indicator.

The control system 114 may also be configured to disable the function that automatically places document boundary flags at the beginning and end of the documents provided to the scanner. For example, a document may comprise different size pages, some of which cannot be scanned through the ADF. Consequently, the operator may manually or verbally designate the beginning and end of the document, for example using a START DOC GROUP button 616 and a STOP DOC GROUP button 714 to identify the beginning and end boundaries of a document, or appropriate verbal commands. For example, the operator may tap the START DOC GROUP button 616 or say “start group” to indicate the beginning of a document group, remove the binding elements, indicate the types of binding elements via the binding elements display, and indicate a description, if desired. Text of a description may be automatically checked for spelling.

The control system 114 stores a flag for the first image, indicating that the image is the first image in the document group, along with any appropriate flags relating to binding elements. Items to be copied may then be imaged, for example via the ADF and/or the flatbed using the appropriate scanning operations, such as the SCAN STAPLE DOCUMENT, SCAN LOOSE DOCUMENT, or the SCAN SINGLE-PAGE DOCUMENT buttons or commands. The operator may then reassemble the original documents into their original form with the original binding elements. Upon completion of the document group, the operator may tap the STOP DOC GROUP button 714 or provide a corresponding verbal command to indicate the end of the group. The control system 114 responds by storing an indicator that the preceding image corresponds to the end of the group.

In addition, upon initiation of the imaging, the control system 114 may provide a proposed image key or other reference number to the operator, for example for Bates numbering or otherwise cataloguing the documents. The user may accept the number, decline to start the numbering at all, or change the starting number. The user may also adjust various parameters relating to the image keys, such as upper or lower case text, suppression of leading zeros, placement of the image key on the page, and printing a single- or multi-line message over the image key.

Referring again to FIG. 4, upon acceptance of the reference number, the control system 114 inserts the reference number into the electronic image when the image is generated (260). Unless otherwise configured, the control system 114 also causes the scanner to generate a copy of the document (262) with the reference number inserted in the image. Thus, the scanner suitably generates the electronic image and the copy substantially concurrently. Insertion of the reference number into the image and/or the physical copy may be selectively enabled or disabled. In addition, the control system 114 may store the reference number as well as the image to facilitate operations relating to the images using the reference numbers, such as searching by reference numbers (e.g., finding a document with a particular Bates number), printing by reference numbers (e.g., printing a set of documents by specifying a range of Bates numbers), deleting documents associated with a selected range of reference numbers, and exporting images according to reference number.

Referring again to FIGS. 6 and 7, the control system 114 may offer any other appropriate options for making the physical copies and/or electronic images. For example, the main GUI 610 may include simplex/duplex buttons 716 and/or voice command responses for scanning simplex or duplex documents. The main GUI 610 may also include one or more paper sizing buttons 717 and image sizing buttons 728 and/or corresponding verbal commands for manually or automatically selecting the paper size and image size for the image. Other options may include contrast options 612 for adjusting the darkness or lightness of the image, and print options on a print panel 720 for simultaneously printing one or more copies of the images as they are generated by the scanner 110. Additional imaging enhancement features may be accessed via a Print Options button 722, which suitably opens a window for further imaging options, such as adjusting clipping values, margins, despeckling, and blank page detection thresholds.

The control system 114 may also accommodate atypical documents. For example, pages in landscape format may be flagged as such so that the image is later automatically displayed as landscape without rotating the image. Checks may be scanned such that the front and back of the check are placed in the same image, so that both the front and back of the check are printed on one side of the same page. The control system may also scan facing pages of a book and automatically generate a separate image for each of the facing pages with different image keys for each page. The book pages may also be flagged to indicate which image is based on the backside of a particular page.

The control system 114 may also offer additional functions while scanning. In the present embodiment, the control system 114 may perform OCR as the images are generated. The OCR may be performed for the entire page, or only for specified zones, such as portions of a form that may be completed with relevant information. The process may repeat for each document provided to the scanner 110 until all of the documents have been scanned.

The imaging system 100 of the present embodiment generates, stores, and manages images from sources other than paper or other physical documents. For example, electronic conversion system may convert electronic files, such as e-mails, document files, image files, and graphics files, to images in a uniform format and integrate the images into new or existing document collections. The electronic conversion system may also perform related functions for using the images, such as extracting text and metadata from electronic files and performing OCR.

In the present embodiment, the EDD system 124 processes the electronic files. The EDD system 124 suitably sets up the conversion process, captures the file data, processes the file data to generate image data, and outputs the images. The EDD system 124 may be implemented in any suitable manner, such as by guiding the user through the process using dialog boxes to initiate processes and set parameters. The EDD process may be initiated and controlled at the operator interface 112 or via another system such as a remote computer, and may access data stored at any suitable location, such as on a CD ROM disc in a local drive, a remote storage device via a network, or a local hard drive.

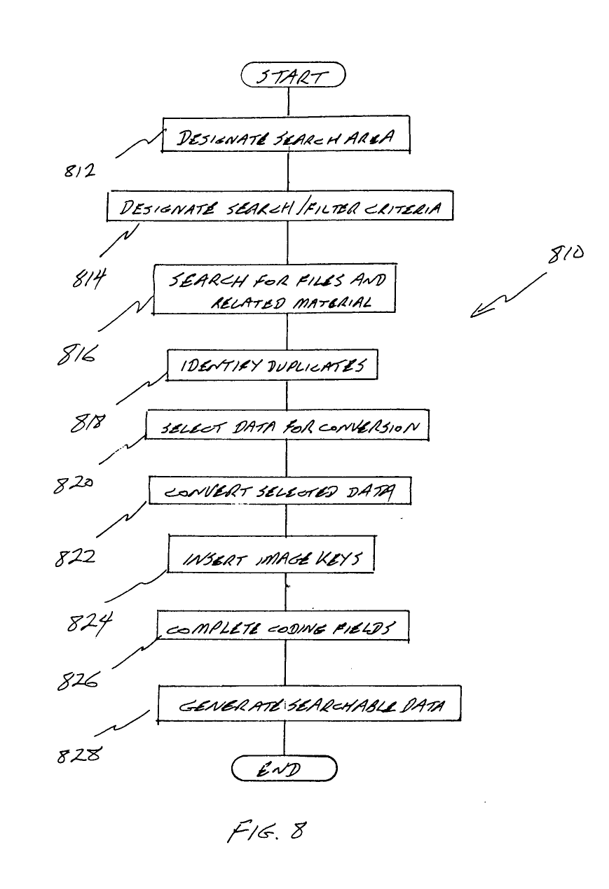

For example, referring to FIG. 8, the operator may initiate an EDD process 810, such as by clicking on an EDD button on the operator interface 112 or at a remote station. The operator may designate a search area, such as specifying a file or one or more folders, drives, and/or directories, for example in response to a prompt from the EDD system 124, or the EDD system 124 may use a search area retrieved from storage (812). The search area may include any suitable data, including electronic files, e-mails, and attachments. The EDD system 124 may also receive or retrieve search or filter criteria to identify material of interest within the search area (814). For example, the operator may identify selected types of files and/or applications, beginning and ending dates for date ranges, words or phrases in the documents or meta-data, and the like.

The operator may then initiate preliminary processing of the designated search areas. The preliminary processing may comprise any suitable procedures for identifying and selecting the information for conversion into images. For example, in the present embodiment, the EDD system 124 suitably searches the designated search area and identifies all files or other information within the search and/or filter parameters (816). The EDD system 124 may also identify related information, such as attachments or linked documents.

The EDD system 124 may further identify duplicates in the identified files using any suitable process (818). In the present embodiment, the operator may select from multiple criteria for identifying duplicates. For example, the operator may select comparison of possible duplicate files on a bit-by-bit basis, comparison of hash, such as MD5 hash, generated from the potentially duplicative files, comparison solely of name and file size, or to forego duplicate identification altogether.

The EDD system 124 may present the identified information to the operator for review. Duplicate information may be highlighted for the operator or automatically removed. The operator may select files for omission or inclusion in the EDD batch (820). Further, the EDD system 124 may provide a viewer for viewing the documents before proceeding, which may allow the operator to review the file contents or related information and decide whether to proceed with processing the file.

The operator may also provide information relating to the EDD files to be generated by the EDD system 124 upon processing of the selected electronic data. The preferences may be selected for all files or may be different for different types of files. For example, the operator may select types of metadata to include for each generated file, such as revisions, headers, formulas, and comments. The metadata may comprise metadata extracted from the target files or may be generated by the EDD system 124. The EDD system 124 may also request and receive operator preferences regarding whether to assign image keys to the images, and the parameters for the image keys, such as format, starting number or letter, and location in the image. The operator may also provide any other suitable information for the EDD process, such as boundary level settings and coding fields.

The EDD system 124 may then convert the selected information to images (822). The EDD system 124 is suitably configured to recognize and convert files that are anticipated to be encountered in the particular application, such as industry-standard files, common e-mail formats, and the like. Further, the EDD system 124 may recognize and convert information based on any suitable characteristics, such as file extensions or other file properties, including file header information. The EDD system 124 may also capture and convert unusually sized and shaped images, such as by cropping and re-sizing images. The EDD system 124 suitably generates boundary flags and other such information to track the organization of the electronic documents. In addition, text off-setting information, such as coloration, highlighting, and the like, may be included in the images. The EDD system 124 may convert the information to any suitable format, such as one or more conventional and accepted litigation formats or other format suitable for the information's ultimate use.

The EDD system 124 may also provide additional information relating to the images and/or adjust the images. For example, the EDD system 124 of the present embodiment may insert standard or custom images keys into the images (824). The EDD system 124 also suitably extracts text and metadata from the target information and generates metadata and/or coding field information to be associated with the resulting image (826). Further, the EDD may perform OCR on the information, create new files including the relevant text and other information in an accessible format, convert e-mails to an accessible format, or otherwise generate searchable information (828). The images and related information may then form a new document collection or may be merged into another.

Referring again to FIGS. 3 and 4, the imaging system 100 may be further configured to facilitate reviewing and adjusting the images, for example for quality control (314, 264). The imaging system 100 may be configured in any suitable manner to facilitate review of electronic images. In the present embodiment, the images may be reviewed via any system, such as the operator interface 112 or a remote computer having access to a network to which the scanner 110 and/or the control system 114 is directly or indirectly connected. The images may be reviewed at any time, such as during generation of the images or after full or partial completion of a document collection. Thus, images may be reviewed concurrently with the imaging process or at a later time, such as while the scanner 110 is unavailable. By viewing the images at a separate workstation, the images may be reviewed for quality control substantially concurrently with the generation of the images or at the convenience of the quality control personnel.

In the present embodiment, the computer system for reviewing the images executes an image review program, which may be integrated into the imaging system program and may function as a separate program as well. For example, the main GUI 610 is suitably configured to include options for reviewing and manipulating images that have already been generated. The options may include functions for any suitable purpose, such as reviewing the images for content, performing quality control or other manipulation of the images, preparing indexes or databases for the images, despeckling, or any other suitable process.

In the present embodiment, the main GUI 610 includes options for finding and reviewing various images. Referring again to FIG. 6, the main GUI 610 may include a FIND IMAGE button 620, which opens a dialog box to allow the operator to enter identifying or search information for a particular image, such as an image key. The main GUI 610 also includes one or more image navigation buttons 624 for browsing the images. In the present embodiment, the navigation buttons 624 include forward and reverse buttons for browsing through the images, such as in increments or decrements of eight, one hundred, or other appropriate number. The navigation buttons 624 also include buttons for going to the first image in the collection and the last image in the collection. The navigation functions may also be implemented via verbal commands. Further, the image review program may be configured to automatically advance through the images, and the speed of the automatic advancement may be selected and/or adjust by the operator.

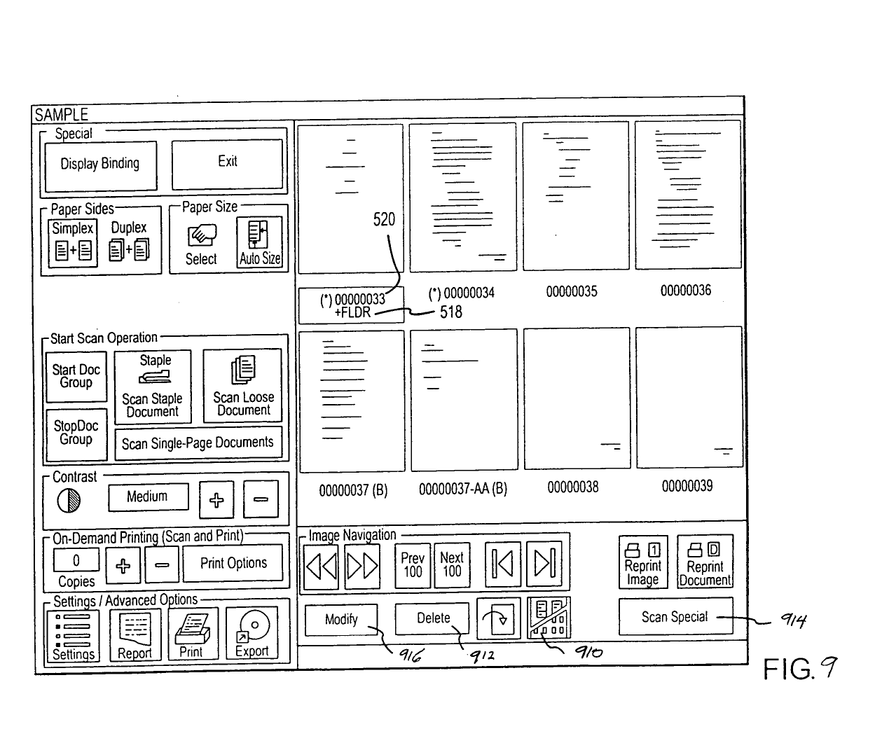

The image review program may facilitate any appropriate viewing options. When navigating through the images, the control system 114 suitably retrieves images from the memory and provides them to the user in an image review area 622. A preselected number of images may be presented at a time, such as eight thumbnail versions of the images (FIG. 9). If the operator wishes to enlarge one image, the operator selects the image, such as by double-tapping the thumbnail version of the image, and the control system 114 presents an enlarged version of the single image. If the operator wishes to view two images at a time, the operator may designate the first image to be viewed by selecting it, then selecting a THUMBNAIL toggling button 910. The control system 114 switches the view to present only two larger images, the image designated and the next image. In the dual-image mode, the navigation buttons may have different operations, such as to navigate by one- or two-image increments. The operator may return to the eight thumbnail images from either the single-image view or the dual-image view by tapping the THUMBNAIL toggling button 910.

The control system 114 may also be configured to facilitate the insertion, deletion, and modification of the images. For example, the operator may designate a particular image and tap the DELETE button 912. In the present embodiment, the control system 114 generates a DELETION window, which offers various deletion selections, such as to delete the designated image, to delete the entire document of which the image is a part, to delete the image and insert a placeholder, such as text like “This page intentionally left blank” or an entry for a privilege log, or to identify a range of images to be deleted. The control system 114 may also be configured to automatically remove blank pages from the document collection.

Conversely, the control system 114 may facilitate the insertion of images into a document or document collection. For example, in the present embodiment, the operator suitably selects an initial image and indicates whether the images to be inserted are simplex or duplex images. The operator may then select the SCAN SPECIAL button 914, which opens a dialog box offering one or more image insertion options. The insertion options may comprise, for example, adding a missing duplex side to a document, inserting additional pages before or after the selected document, or rescanning the selected image or range of images. The operator may then provide the documents to be imaged, such as on the flatbed or in the ADF, and taps the desired scanning option button. The scanner 110 then generates images corresponding to the documents and the control system 114 inserts them into the set of documents according to the scanning option selected. Alternatively, the operator may designate documents or images of documents to be imported into the collection or document. Such images may be scanned from a directory, such as a source, scan-to-file, file-transfer protocol (FTP), or e-mail directory, which bypasses the need for a TWAIN driver. The control system 114 suitably reads the document or image from storage, converts the document to the desired image format (if necessary), and inserts the images.

The operator may also elect to modify one or more images, for example via a MODIFY option 916. For example, the MODIFY options may any appropriate options, such as a ROTATE CURRENT IMAGE 180 DEGREES or ROTATE CURRENT IMAGE 90 DEGREES, which rotates an image that may have been scanned upside down or sideways. Other modification options may be to adjust brightness or contrast, perform despeckling, remove black borders, adjust image size, inserting notations, color enhancements, or any other appropriate image modifications.

In addition, the control system 114 may add, remove, or adjust image keys associated with the images. In the present embodiment, the image review program may automatically change the image keys for all images subsequent to an inserted image to maintain the proper sequence. Alternatively, the image review program may add, automatically or upon instruction, a suffix to the image key for the added documents. For example, if an image is added, the control system 114 may assign a suffix to a relevant image key to identify the added document's position in the sequence of documents. The suffix may comprise any suitable designator, such as a conventional alphanumeric suffix having one to three characters. Thus, an image added after image [203] may be assigned an image key of [203-AA], and the suffix may be incremented for following pages to be inserted, i.e., [203-AB], [203-AC], etc. Further, the image review program may automatically generate and insert appropriate image keys if the images do not include image keys, or may delete existing image keys. The user may also adjust the image keys in any suitable manner, such as to select a new starting number for the image keys or add a custom prefix or suffix, such as a case number.

The control system 114 may also facilitate renumbering of the image keys or other reference numbers, for example to retain or eliminate suffixes, change numbering formats, or adjusting starting numbers. For example, the MODIFY button 916 may opens a dialog box offering various modification options. Selecting a RENUMBER ENTIRE COLLECTION option causes the current collection, including multiple-box collections, to be renumbered, eliminating any suffixes. If desired, however, the operator may retain the suffixes. The operator may also split a document collection into multiple document collections and automatically adjust the image keys. The operator may also renumber a selected set of documents using a RENUMBER RANGE option.

The image review program may also facilitate inserting, deleting, and adjusting the information relating to the images, such as the organizational information, the document boundaries, and various flags. For example, when images are inserted into the document collection, the control system 114 may generate relevant flags, for example to designate whether the image is associated with a binding element, a document boundary, or the duplex side of another image. The document flags may also be modified. The document flags may be represented in any suitable manner to indicate the corresponding document boundaries, binding elements, and other characteristics. In the present system, symbols 518 are presented alongside the image keys 520 when the images are being reviewed. Different symbols may designate, for example, document boundary flags, staples, duplex sides of documents, and binding elements. Additional symbols may be used to identify additional characteristics, such as whether a binding element symbol indicates the beginning or the end of the bound materials.

After selecting an image, the operator may select the MODIFY button 516 and select a SET/REMOVE DOCUMENT FLAG ON CURRENT IMAGE option. Upon selection, the control system 114 suitably offers a subsequent dialog box offering additional options, such as SET LOOSE DOCUMENT FLAG, SET STAPLE DOCUMENT FLAG, and REMOVE DOCUMENT FLAG. Similarly, after selecting the MODIFY button, the operator may select SET/REMOVE BACKSIDE FLAG ON CURRENT IMAGE to adjust the status of the duplex side flag.

Further, the operator may select a MODIFY BINDING ELEMENTS option after selecting the MODIFY button. If the selected document has a document boundary flag, the control system 114 may open a window to modify the binding elements, which suitably includes the selection of possible binding types from which the operator may select. If the document does not have a document boundary flag, a different window opens, allowing the operator to either set a loose document flag or a staple document flag. In addition, the operator may select an ADD/MODIFY DESCRIPTION button to add or modify a description corresponding to a document flag, binding element, document, collection, or box.

In one embodiment, the control system 114 or other system may facilitate generation of a list of folder descriptions or other information for insertion into the description field. The list may be accessed to select a predetermined description for entry, such as via a drop-down menu. The list may be accessed at any appropriate time or location, such as at scan time on the scanner 110 or later at a quality control or reviewing station. In addition, the control system 114 may allow the operator to use the same description previously applied to simplify the entry of descriptions for multiple documents or sets of documents having the same description. The image review program may also include an option for closing all binding elements to efficiently indicate the coinciding end of several binding elements.

Information converted to images may also be provided to the document coding system 122 to generate index information for the documents. The document coding system 122 may facilitate generating index information according to any suitable process or system. The document coding system 122 suitably handles various aspects of the coding process, such as project definition and setup, unitization, coding and quality control assignment, data validation, and export of the completed files into a database. Further, the document coding system 122 may include a security system to specify which users may perform certain functions and inhibit inappropriate access to project definitions, coded data, document images, and other restricted information.

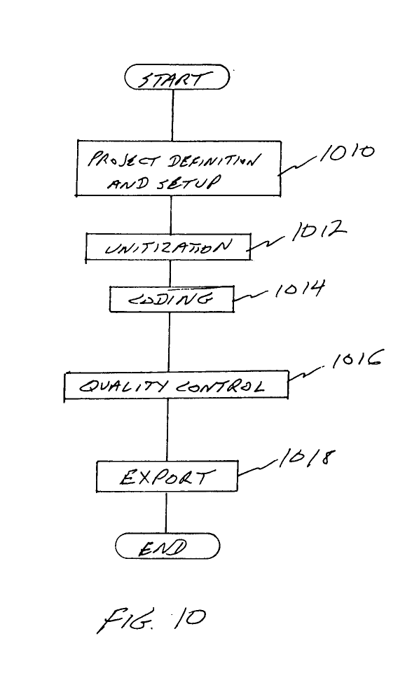

In the present embodiment, referring to FIG. 10, the document coding system 122 initially performs various setup operations 1010, such as project definition for a particular coding job. Project definition may include information for the particular coding job, such as a series of coding field definitions. Further, the coding fields may include any desired fields for the particular application. The coding fields may include one or more standard coding fields as well as one or more customized field definitions for the particular document type, application, environment, or preferences. The document coding system 122 may utilize templates to provide default or model coding fields. Any additional information may also be generated, such as selecting preferred date formats, generating lists of names or document types for selection from lists.

Further, the document coding system 122 may set up coding teams, for example by compiling lists of unitizing personnel, coding personnel, and quality control personnel for handling coding jobs. In addition, the document coding system 122 may include security functions for establishing authorization and access for various personnel, such as to prevent inappropriate access to project definitions, coded data, and document images. Thus, the document coding system 122 may specify which users can perform certain functions, such as unitizing, coding, quality control, or administrative functions. In addition, the document coding system 122 may select certain coding fields for limited access and/or viewing by selected personnel.

The image data for the coding project may be received, for example from the image server, and unitized (1012). Unitization may comprise any suitable process for identifying particular document boundary information relating to the images, such as identifying the beginning and end of each document, folder, box, or the like. Unitization may also include identifying dates, relationships between documents, such as attachments and appendices, document types, such as graphs, e-mails, memoranda, and the like. The unitization information may then be stored and associated with the relevant images.

The document coding system 122 may facilitate creation of unitization batches for handling by different personnel. For example, the document coding system 122 may allow a unitization job to be separated into multiple batches of images for unitization. The batches may be selected according to any suitable criteria, such as a selected number of images or documents, and may be generated either automatically or manually, such as by an administrator.

Unitization may be performed in any suitable manner. In the present embodiment, the document coding system 122 uses the document boundary information generated by the scanner 110. The information may be checked to ensure it is valid, either automatically or manually. Alternatively, if the unitization information is not readily available or complete, the information may be generated manually, for example by reviewing the individual images and electronically marking or entering the unitization information. In the present document coding system 122, document type flags, document boundary markers, and other data may be electronically designated to facilitate efficient setting of document types, document and attachment boundaries, date indicators, and the like. Further, the document coding system 122 may provide shortcuts that allow personnel to skip fields, for example for certain types of documents, to improve the efficiency of the personnel performing the unitization.

Upon completion of a unitization batch, the unitization information may be automatically analyzed for validation. Validation may comprise analyzing the data according to any suitable criteria to detect errors in data entry. For example, the validation process may review dates to ensure that they conform to the required date format and fit within accepted date ranges. The document coding system 122 may be configured to accommodate missing or partial dates, for example when only a month and day are specified in the image. The validation process may also check for overlaps and gaps between documents that may reflect an error in data entry.

Following unitization, the document coding system 122 suitably prepare the document coding job for coding. For example, the document coding system 122 may facilitate creation of coding batches, such as by separating the coding job into set of images for handling by different coding teams. Coding batches may be selected and/or adjusted automatically and/or manually and according to any suitable criteria, such as the number of images or documents in a coding batch. Further, the coding batches may be organized in any suitable manner, such as according to image keys, document type, and OCR confidence levels. Batches may be assigned to a specific team and/or a specific or next available user.

The document coding system 122 may then grant access to a coding batch to a coding team, which extracts data from the images and populates the coding fields (1014). The document coding system 122 may support multiple domains, allowing separate systems to reside on the same Internet server using the same IP address to optimize hardware use without sacrificing security. Alternatively, the document coding system may automatically complete some or all of the coding fields, for example by extracting relevant metadata and/or full text from the converted images, or by calculating relevant information such as the number of pages in the document. The data may then be used to populate various coding fields in a database, which are suitably associated with the corresponding documents. The document coding system 122 may also allow the user to review the document, for example using a built-in viewer, to review the document and verify the coding field entries.

The extraction of the information for the coding fields and entry of data into the coding fields may be performed according to any suitable technique or process, such as by typing the entries into the field or selecting an appropriate entry from a read-only or modifiable list. In the present embodiment, the document coding system 122 provides zonal OCR, which allows the coding personnel to designate an area in an image for OCR. Thus, the coding personnel may highlight an area in an image and the highlighted information is converted to a text format, which may then be copied into a coding field. The document coding system 122 may provide shortcuts that allow coding personnel to skip fields, for example for certain types of documents, to improve the efficiency of the personnel performing the coding. Further, the setup may provide for indexing documents according to document type, keywords, financial transactions, sources or addressees, and/or other criteria.

The document coding system 122 may also provide various additional functions for enhancing the coding process. For example, the document coding system 122 of the present embodiment includes a communication tool, such as an e-mail, instant messaging, or vocal conference system. The communication tool may facilitate exchange of information between the various personnel, for example to alert an administrator of errors or difficulties in the process. The document coding system 122 may also allow coding personnel to annotate images or jobs, for example reflecting the level of difficulty or other information that may be of use.

The document coding system 122 may also be configured to perform validation on the coding information. Validation may comprise analyzing the data according to any suitable criteria to detect errors in data entry, such as inappropriate dates and overlaps or gaps.

The document coding system 122 may also facilitate quality control (1016), which may be performed in any suitable manner. For example, the document coding system 122 may transfer completed coding jobs to quality control personnel for review. The quality control personnel may review and revise the coding entries received from the coding personnel. In addition, the document coding system 122 may perform automatic quality control, such as analyzing the coding entries to ensure data integrity for output to the major litigation database standards. Automatic quality control may include, for example, image key validation, required fields validation to ensure that all required fields are populated, names consistency evaluation to ensure that names are reflected identically throughout the coding job, spell-checking, and image key gap detection. If desired, the document coding system 122 may mark a coding batch for rework and/or reassignment, such as by designating the batch for a particular coding team or returning the coding batch to a coding queue.

The resulting coding data may then be prepared for use by the end user (1018). For example, the document coding system 122 suitably exports the data to a text file that may be used by the end user, for example for importation into a litigation database. The document coding system 122 may also generate any suitable reports to manage productivity, estimate completion times, track batch, user, shipment, and project status. The document coding system 122 of the present embodiment may also generate reports to verify project boundaries, including levels, descriptions, and icons, generated by the scanner 110 and/or the unitization process.

The imaging system 100 may also provide various functions for using and analyzing the images generated. For example, the imaging system 100 may provide reports relating to generated images. The imaging system 100 also provides functions for printing the images, exporting the images to another system or another medium, and merging or splitting document collections. Troubleshooting and administrative functions may be included as well.

For example, the control system 114 of the present embodiment may provide reports relating to scanning and printing operations. The reports may comprise any suitable reports that may be useful in the particular application or environment. For example, the control system 114 may provide a REPORT button 630 on the main GUI 610 (FIG. 6) that accesses one or more report options, such as a Box Summary report or a Full Detail Manifest Report. The Box Summary report may give an abbreviated report relating to a particular document collection, such as providing image keys and names of folders in the collection, along with general information such as page count, document count, folder count, number of gaps, and range of image keys for the collection. The Full Detail Manifest Report suitably provides a more detailed report, such as providing indications of binding element starts and stops, folder names, loose and/or stapled document image key ranges, number of pages in each document set, image key range gaps, page count, document count, folder count, and range of image keys.

Additional reports may be generated for any purpose, such as administrative and accounting purposes. In one embodiment, job cost data associated with an imaging job may be assembled and reporting in a predetermined format. The control system 114 may also be configured to interface with legal cost accounting systems, general purpose accounting systems, or other types of systems to track and exchange cost information.

The control system 114 may also generate reports relating to operator performance. For example, an operator may be required to log onto the control system 114 to use the imaging system 100. The administrator or other person having rights may disable the login requirement or disable the operator performance tracking features. The control system 114 may track the number of images made, printed, scanned, or the like, by the operator, as well as the time required, times of use, or any other desired information relating to the use of the imaging system by the operator. The information may be provided as a report, exported to another, or otherwise communicated or stored.

The imaging system 100 may also be configured to facilitate printing portions of or the entire document collection, and suitably offers various printing options and features. For example, the scanner 110 suitably includes a printer for printing information in accordance with signals from any suitable source, such as the control system 114, other scanner 110 components, or the network. Images may be printed from any source, such as the image server, the storage system 116, the scanner 110 memory, the image server 120, a CD-ROM or DVD-ROM drive, or another storage medium. An operator may also print jobs from files incorporating changes to original document collections, such as following quality control. The printer may be configured as a physically separate device connected to other components of the imaging system 100 or may be integrated into the scanner 110, such as in an MFD.

The printer may be configured to provide any suitable print options. For example, as previously indicated, the printer may be configured to selectively print one or more copies of the images as they are being scanned. To turn off the printing function or change the number of copies printed, the operator may change the number of copies via a print panel 420 on the main GUI 610. The concurrent printing option may be turned off by setting the number of copies to zero.

To print images that were previously scanned, the operator may request access to an existing collection, either stored locally, on a storage medium, or at a remote location, and initiate a print operation by tapping a PRINT button 606. In response, the control system 114 may provide a dialog with an array of print options, such as number of copies, paper selection, and range of images to print. The printer may also print individual images or documents by navigating to and selecting the image and tapping the REPRINT IMAGE button 326 or REPRINT DOCUMENT button 328. The printer may also print selected collections of images, such as printing all boxes, a selected box, or the current box.

The printer may also facilitate changing various other options. For example, referring again to FIG. 7, in the present embodiment, the operator may tap the PRINT OPTIONS button 722 on the print panel 720 to open a dialog window for various functions, such as paper tray configuration, simplex/duplex printing, number of copies, whether to print an image, a document, a range of documents, or an entire group, whether to print the image key on the document, and/or image key options, such as image key placement on the document, font, size, and color. Other options may include clipping values to crop black borders printed around an image, margins (for example to allow space for hole-punching), printer page framing options, image scaling, and other suitable print options. Additional printing options may be accessed, such as to facilitate insertion of messages, like CONFIDENTIAL, into images. In one embodiment, the control system 114 or other system may facilitate generation of a list of messages or other information for insertion into the document. The list may be accessed to select a predetermined message for entry, such as via a drop-down menu. The list may be accessed or modified at any appropriate time or location and by any suitable personnel, such as at run time on the scanner 110 or later at a quality control or reviewing station.

In addition, the printer may be configured to print the copies in selected pages sizes, such as matching the size of the original or adjusting the image to fit on a selected page size, such as a standard 8.5″×11″ or A4 page. The printer may also be configured to insert slip sheets, such as colored paper or other marker, at selected positions in the documents, such as between documents or to signify binding elements. The particular type of binding element or other information, such as information corresponding to the document flags, may be printed on the slip sheet, the slip sheets may be left blank, or other information may be printed on them. For example, a slip sheet may indicate that a paper clip or staple begins on a next page and another slip sheet may indicate that the paper clip or staple ends on a preceding page. Alternatively, the operator may turn the slip sheets off to stop printing of the slip sheets. The control system 114 may also use the document flags to selectively generate copies of the original documents, such as by printing duplex side images on the backside of a copy, stapling documents where the originals were stapled, and indicating the proper placement of other binding elements. Further, the control system 114 may be configured to operate in conjunction with a post infuser to insert slip sheets between documents. For example, the control system 114 may direct a signal to the post infuser to insert a slip sheet between documents.

The control system 114 may also provide various administrative functions for managing the images, such as storage, exporting, database management and repair, and merging document collections. For example, the present control system 114 provides an EXPORT button 632 on the main GUI 610 (FIG. 6) that opens a dialog window allowing the operator to select from various export options, such as burning to CD ROM, burning to DVD, and creating export files. When the selection is made, the control system 114 transfers the relevant information to the selected storage device for creating the exported files (266) (FIG. 4).

In addition, the control system 114 may store other programs or data, such as a proprietary or other viewing program or an OCR program, on the storage medium for viewing or processing the document image data. Consequently, a recipient of the DVD, CD ROM, or other storage medium may view the documents by loading the viewer software from the same medium. The viewer software may also facilitate text searches based on the OCR results.

Further, the storage medium may include modification applications for modifying images. For example, the recipient of the medium may activate the modification application, load one or more images, and edit the images or a collection of images. The modification application may facilitate any appropriate functions, such as searching for images or data, such as image keys and OCR data; changing document boundaries; rotating and zooming on images; scrolling; adding, modifying, resizing, or deleting redactions; annotating and highlighting images; adding markups, sticky notes, clips, and embedded text to images; tagging images; and printing images with or without changes. The modification program may interface with third party applications, such as Summation and Concordance. The modification software may also include a customizable user interface, for example a sizable, dockable, floatable, moveable, and/or hideable interface.

The document collection or other sets of documents may also be exported to files for transfer to another system or entity for additional processing. For example, the control system 114 may export a set of documents, such as a document collection, a box of documents, or the like, to a file, and then electronically transfer the file to a third party. The third party may perform various tasks relating to the documents, such as performing OCR on the documents or generating indexes for the documents. The third party may then transfer the results of such operations back to the imaging system 100, which may then export the document collection and all associated information to another medium. As a result, a CD ROM, DVD, or other storage medium may contain the images of the document collection, a document viewer and editing system, an OCR file having OCR data for the document images, and a document coding index or other database facilitating use of the documents. Various data may also be subject to security provisions, such as encryption of the OCR data, to control access to selected data.

The control system 114 may also facilitate merging multiple document collections, such as collections of images generated by different imaging stations. For example, to maximize throughput, multiple imaging systems 100 may handle a single imaging job, generating multiple document collections that relate to the same job. To merge the multiple collections into a single collection, the main GUI 610 suitably includes a MERGE COLLECTIONS button (not shown). Upon selection of the MERGE COLLECTIONS button, a list of accessible collections is presented, such as collections stored on the network, on the imaging system 100, or on other connected imaging system 100s. The operator may then select the document collections for merging and a starting image key or other designation for the merged document collection. The control system 114 then processes the merge by creating a single document collection for all of the images in the designated collections. The images are suitably renumbered using the selected starting image key. Conversely, the control system 114 may facilitate splitting a single collection into multiple collections.

The control system 114 may offer various other utilities for managing the imaging system 100. For example, the present imaging system 100 facilitates database repair for designated databases and automatic and/or manual purging of document collections, for example following a selected number of days, from the imaging system 100's storage. In addition, the utilities allow collections to be selectively exempted from automatic purging.

The control system 114 may also provide various troubleshooting tools. For example, the control system 114 may display error messages, such as error messages related to the scanner 110 or control system 114, on the interface 112 or at a remote station. The error messages may also include associated help information. The control system 114 may further include various troubleshooting and debugging tools for the imaging program and the network connections.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a preferred embodiment. However, changes and modifications may be made to the preferred embodiment without departing from the scope of the present invention. These and other changes or modifications are intended to be included within the scope of the present invention.

1. A system for making images, comprising:
a storage system; and
a scanner connected to the storage system and configured to substantially concurrently:
generate the images in an image format based on multiple documents;
store the images in the storage system; and
print copies of the images.

2. A system for making images according to claim 1, further comprising an electronic conversion system connected to the storage system and configured to generate images in the image format based on electronic information.

3. A system for making images according to claim 1, wherein the storage system comprises an image server.

4. A system for making images according to claim 1, wherein the multiple documents include electronic documents.

5. A system for making images according to claim 4, wherein the electronic documents include e-mails, word processing files, spreadsheet files, and graphics files.

6. A system for making images according to claim 1, further comprising a document coding system connected to the storage system and configured to record indexing information relating to the images.

7. A system for making images according to claim 1, further comprising an optical character recognition (OCR) system configured to perform OCR on the images.

8. A system for making images according to claim 7, wherein:
at least one of the documents comprises more than one page;
the OCR system is configure to generate a single OCR file for data on more than one page of the document.

9. A system for making images according to claim 1, wherein the scanner is configured to record a relationship between a first document and a second document.

10. A system for making images according to claim 1, wherein the scanner is further configured to insert image keys into the generated images.

11. A system for making images according to claim 10, wherein the scanner is configured to store the images using file names including the image keys.

12. A system for making images according to claim 10, wherein the scanner is further configured to:
insert additional images between a first image having a first image key and a second image having a second image key;
insert image keys having suffixes into the additional images, wherein the suffixes are sequentially ordered.

13. A system for making images according to claim 1, wherein the scanner is further configured to:
identify paper sizes of the documents; and
print copies of the images on paper of substantially the same size as the identified paper sizes.

14. A system for making images according to claim 1, wherein the scanner is configured to:
identify whether the documents are simplex or duplex formats; and
print copies of the images in the identified document formats.

15. A system for making images according to claim 1, wherein the scanner is configured to:
compare an amount of data on the document to a threshold; and
generate the image of the document only if the amount of data exceeds the threshold.

16. A system for making images according to claim 1, wherein the scanner is configured to store the images in color.

17. A system for making images according to claim 1, further comprising a viewing system connected to the storage system and configured to facilitate viewing the images at run time.

18. A system for making images according to claim 1, wherein the scanner is configured to:
recognize a black border around the image; and
remove the black border from the image.

19. A system for making images according to claim 1, wherein the scanner is configured to:
scan facing pages of a book; and
automatically generate a separate image for each of the facing pages.

20. A method of making images of documents, comprising:
generating images in an image format based on multiple documents;
storing the images in a storage system; and
making a physical copy of the documents substantially concurrently with the generation of the electronic images of the documents.

21. A method of making images according to claim 20, further comprising generating images in the image format based on electronic information.

22. A method of making images according to claim 20, wherein the storage system comprises an image server.

23. A method of making images according to claim 20, wherein the multiple documents include electronic documents.

24. A method of making images according to claim 23, wherein the electronic documents include e-mails, word processing files, spreadsheet files, and graphics files.

25. A method of making images according to claim 20, further comprising recording indexing information relating to the images.

26. A method of making images according to claim 20, further comprising performing optical character recognition (OCR) on the images.

27. A method of making images according to claim 26, wherein:
at least one of the documents comprises more than one page;
performing OCR on the images includes generating a single OCR file for data on more than one page of the document.

28. A method of making images according to claim 20, further comprising recording a relationship between a first document and a second document.

29. A method of making images according to claim 20, further comprising inserting image keys into the generated images.

30. A method of making images according to claim 29, wherein inserting the image keys comprises storing the images using file names including the image keys.

31. A method of making images according to claim 29, further comprising:
inserting additional images between a first image having a first image key and a second image having a second image key;
inserting image keys having suffixes into the additional images, wherein the suffixes are sequentially ordered.

32. A method of making images according to claim 20, further comprising:
identifying paper sizes of the documents; and
printing copies of the images on paper of substantially the same size as the identified paper sizes.

33. A method of making images according to claim 20, further comprising:
identifying whether the documents are simplex or duplex formats; and
printing copies of the images in the identified document formats.

34. A method of making images according to claim 20, further comprising:
comparing an amount of data on the document to a threshold; and
generating the image of the document only if the amount of data exceeds the threshold.

35. A method of making images according to claim 20, further comprising storing the images in color.

36. A method of making images according to claim 20, further comprising viewing the images at run time.

37. A method of making images according to claim 20, further comprising:
recognizing a black border around the image; and
removing the black border from the image.

38. A method of making images according to claim 20, further comprising:
scanning facing pages of a book; and
automatically generating a separate image for each of the facing pages.

39. An imaging system, comprising:
a storage system;
a scanner configured to generate image data in an image format based on multiple documents; and
a control system connected to the scanner and configured to substantially concurrently store the electronic image data in the storage system and generate physical copies of the documents.

40. An imaging system according to claim 39, further comprising an electronic conversion system connected to the storage system and configured to generate image data in the image format based on electronic information.

41. An imaging system according to claim 39, wherein the storage system comprises an image server.

42. An imaging system according to claim 39, wherein the multiple documents include electronic documents.

43. An imaging system according to claim 42, wherein the electronic documents include e-mails, word processing files, spreadsheet files, and graphics files.

44. An imaging system according to claim 39, further comprising a document coding system connected to the storage system and configured to record indexing information relating to the images.

45. An imaging system according to claim 39, further comprising an optical character recognition (OCR) system connected to the storage system and configured to perform OCR on the images.

46. An imaging system according to claim 45, wherein:
at least one of the documents comprises more than one page;
the OCR system is configure to generate a single OCR file for data on more than one page of the at least one of the documents.

47. An imaging system according to claim 39, wherein the control system is configured to record a relationship between a first document and a second document.

48. An imaging system according to claim 39, wherein the control system is configured to insert image keys into the generated images.

49. An imaging system according to claim 48, wherein the control system is configured to store the images using file names including the image keys.

50. An imaging system according to claim 48, wherein the control system is configured to:
insert additional images between a first image having a first image key and a second image having a second image key;
insert image keys having suffixes into the additional images, wherein the suffixes are sequentially ordered.

51. An imaging system according to claim 39, wherein the control system is further configured to:
identify paper sizes of the documents; and
print copies of the images on paper of substantially the same size as the identified paper sizes.

52. An imaging system according to claim 39, wherein the control system is configured to:
identify whether the documents are in simplex or duplex formats; and
print copies of the images in the identified document formats.

53. An imaging system according to claim 39, wherein the control system is configured to:
compare an amount of data on the document to a threshold; and
generate the image of the document only if the amount of data exceeds the threshold.

54. An imaging system according to claim 39, wherein the control system is configured to store the images in color.

55. An imaging system according to claim 39, further comprising a viewing system connected to the control system and configured to facilitate viewing the images at run time.

56. An imaging system according to claim 39, wherein the control system is configured to:
recognize a black border around the image; and
remove the black border from the image.

57. An imaging system according to claim 39, wherein the control system is configured to:
scan facing pages of a book; and
automatically generate a separate image for each of the facing pages.

58. A computer system configured to:
control a scanner to generate image data in an image format corresponding to a set of images;
control the scanner to make a physical copy of the images substantially concurrently with generating the image data; and
store the image data in a storage system.

59. A computer system according to claim 58, wherein the computer system is further configured to generate image data in the image format based on electronic information.

60. A computer system according to claim 58, wherein the storage system comprises an image server.

61. A computer system according to claim 58, wherein the set of images include images of electronic documents.

62. A computer system according to claim 61, wherein the electronic documents include e-mails, word processing files, spreadsheet files, and graphics files.

63. A computer system according to claim 58, wherein the computer system is further configured to record indexing information relating to the images.

64. A computer system according to claim 58, wherein the computer system is further configured to perform optical character recognition (OCR) on the image data.

65. A computer system according to claim 64, wherein:
a subset of the set of images corresponds to a document comprising more than one page;
the computer system is further configured to perform OCR on image data for the subset of images and generate a single OCR file for image data corresponding to information on more than one page of the document.

66. A computer system according to claim 58, wherein:
the set of images corresponds to a set of documents; and
the computer system is further configured to record a relationship between a first document and a second document.

67. A computer system according to claim 58, wherein the computer system is further configured to insert image keys into the generated image data.

68. A computer system according to claim 67, wherein the computer system is further configured to store the images using file names including the image keys.

69. A computer system according to claim 67, wherein the computer system is further configured to:
insert additional image data corresponding to additional images, wherein the additional images are inserted between a first image having a first image key in the image data and a second image having a second image key in the image data;
insert image keys having suffixes into the additional image data for the additional images, wherein the suffixes are sequentially ordered.

70. A computer system according to claim 58, wherein the computer system is further configured to:
identify paper sizes of documents in the images; and
print copies of the documents on paper of substantially the same size as the identified paper sizes.

71. A computer system according to claim 58, wherein the computer system is further configured to:
identify whether documents in the images are in simplex or duplex formats; and print copies of the documents in the identified formats.

72. A computer system according to claim 58, wherein the computer system is further configured to:
compare an amount of data in a selected image to a threshold; and
generate the image data for the selected image only if the amount of data exceeds the threshold.

73. A computer system according to claim 58, wherein the computer system is further configured to generate the color image data.

74. A computer system according to claim 58, wherein the computer system is further configured to present the image data for viewing the images at run time.

75. A computer system according to claim 58, wherein the computer system is further configured to:
recognize a black border around the image; and
remove the black border from the image.

76. A computer system according to claim 58, wherein the computer system is further configured to:
scan facing pages of a book; and
automatically generate a separate image for each of the facing pages.
